(19) United States
(12) Patent Application Publication
(10) Pub. No.: US 2016/0267824 A1
(43) Pub. Date: Sep. 15, 2016

(54) MOUNTING APPARATUS

(71) Applicant: Reggie Lacross, Garland, TX (US)

(72) Inventor: Reggie Lacross, Garland, TX (US)

(21) Appl. No.: 14/805,093

(22) Filed: Jul. 21, 2015

Related U.S. Application Data
(60) Provisional application No. 62/177,093, filed on Mar. 9, 2015.

(51) Int. Cl. G09F 17/00

(52) U.S. Cl. CPC G09F 17/00

(57) ABSTRACT

A method and apparatus for securing a banner without tying down the bottom of the banner. The apparatus comprises a clamping mechanism, a shaft, and a head. The clamping mechanism comprises a first surface and a second surface. The second surface of the clamping mechanism may travel along the shaft. The head is associated with a first end of the shaft. The head has a channel and a hook.

### CROSS-REFERENCE TO RELATED APPLICATIONS

This application claims priority to US Provisional Patent Application No. 62/177,093, filed on Mar. 9, 2015. The provisional application is incorporated herein by reference in its entirety.

### BACKGROUND INFORMATION

1. Field

The present disclosure relates generally to mounting. More particularly, the present disclosure relates to mounting banners. Still more particularly, the present disclosure relates to a method and apparatus for securing a banner without tying down the bottom of the banner.

2. Background

Banners may be a cost effective way to provide information, advertise events, or promote a business. Hanging banners come in a variety of shapes and sizes and may be used indoors or outdoors. Banners hung outdoors may be exposed to wind, rain, sunlight, and other conditions.

Conventional hanging banners may be hung from specialty stands, lampposts, or other structures. Some banners may be hung in front of storefronts to advertise sales or promotions. Hanging banners may need to be secured at the top and the bottom of the banner to provide functionality. For example, by securing a banner at the top and bottom, the banner may be substantially flat. When the banner is substantially flat, the display surface may be visible. Further, when the banner is secured at the top and the bottom, wind damage of the banner may be reduced or prevented.

Grommets may be present in the bottom and the top of the banner. In some examples, to hang a banner, the banner may be secured onto a wall by sending fasteners through the grommets. For example, the banner may be screwed into a wall by sending screws through the grommets. When a banner is attached to a wall using fasteners, the process of attaching the banner may be more time-consuming than desired. Further, when a banner is attached to a wall using fasteners, the fasteners may undesirably impact at least one of the aesthetics or strength of the wall.

In some examples, to hang a banner, rope may be sent through the grommets on the top of the banner. In some other examples, to hang a banner, the grommets on the top of the banner may be placed onto hooks. To secure the bottom of the banner, rope or bungees may be passed through one or more of the grommets. Securing the bottom of a banner using rope may be more time-consuming than desired. Securing the bottom of a banner using rope may also use more labor than desired. Further, when the bottom of a banner is secured using rope, exchanging the banner for another banner may take an undesirable amount of time.

Therefore, it would be desirable to have a method and apparatus that take into account at least some of the issues discussed above, as well as other possible issues. For example, it may be desirable to have a method and apparatus that would reduce the time to secure a banner. As another example, it may be desirable to have a method and apparatus that would reduce the time to replace a banner.

### SUMMARY

In an illustrative embodiment, an apparatus is provided. The apparatus comprises a clamping mechanism, a shaft, and a head. The clamping mechanism comprises a first surface and a second surface. The second surface of the clamping mechanism may travel along the shaft. The head is associated with a first end of the shaft. The head has a channel and a hook.

In another illustrative embodiment, an apparatus for securing a banner without tying down the bottom of the banner is provided. The apparatus comprises a mounting fixture and a rod. The mounting fixture comprises a clamping mechanism, a shaft, and a head. The clamping mechanism comprises a first surface and a second surface. The second surface of the clamping mechanism may travel along the shaft. The head is associated with a first end of the shaft. The head has a channel and a hook. The rod extends through the channel and into a pocket of the banner.

In yet another illustrative embodiment, a method of securing a banner without tying down the bottom of the banner is provided. A structure is clamped using a clamping mechanism of a mounting fixture. A grommet of the banner is hung onto a hook of the mounting fixture. A rod is inserted through a channel of the mounting fixture and into a first pocket of the banner.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a display environment in accordance with an illustrative embodiment;

FIG. 2 is an illustration of an isometric view of a plurality of mounting fixtures holding a banner for display in accordance with an illustrative embodiment;

FIG. 3 is an illustration of an isometric view of a mounting fixture in accordance with an illustrative embodiment;

FIG. 4 is an illustration of a top view of a mounting fixture in accordance with an illustrative embodiment;

FIG. 5 is an illustration of a side view of a mounting fixture in accordance with an illustrative embodiment;

FIG. 6 is an illustration of an exploded back view of a rod, mounting fixture, and banner in accordance with an illustrative embodiment;

FIG. 7 is an illustration of an exploded back view of a rod, mounting fixture, and banner in accordance with an illustrative embodiment;

FIG. 8 is an illustration of a back view of a banner in accordance with an illustrative embodiment;

FIG. 9 is an illustration of a back view of a banner in accordance with an illustrative embodiment;

FIG. 10 is an illustration of a back isometric view of a plurality of mounting fixtures holding a banner for display in accordance with an illustrative embodiment;

FIG. 11 is an illustration of a back view of a plurality of mounting fixtures holding a banner for display in accordance with an illustrative embodiment;

FIG. 12 is an illustration of a back isometric view of a plurality of mounting fixtures holding a banner for display in accordance with an illustrative embodiment;

FIG. 13 is an illustration of a top view of a mounting fixture in accordance with an illustrative embodiment;

FIG. 14 is an illustration of a side view of a mounting fixture in accordance with an illustrative embodiment;

FIG. 15 is an illustration of a top view of another mounting fixture in accordance with an illustrative embodiment;

FIG. 16 is an illustration of an isometric view of a mounting fixture in accordance with an illustrative embodiment;

FIG. 17 is an illustration of an exploded back view of a plurality of rods, a plurality of mounting fixtures, banner, and a plurality of bottom straighteners in accordance with an illustrative embodiment;

FIG. 18 is an illustration of an isometric view of a bottom straightener in accordance with an illustrative embodiment; and

FIG. 19 is an illustration of a flowchart of a process for securing a banner without tying down the bottom of the banner in accordance with an illustrative embodiment.

### DETAILED DESCRIPTION

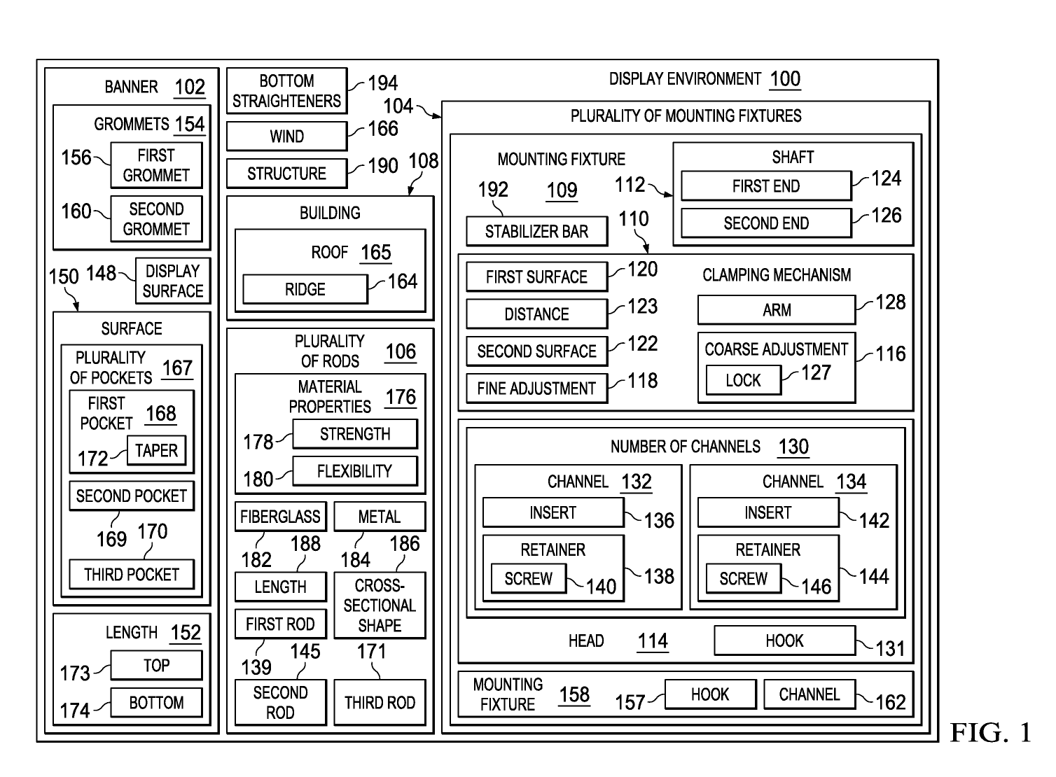

With reference now to the figures, and in particular, with reference to FIG. 1, an illustration of a block diagram of a display environment is depicted in accordance with an illustrative embodiment. In this illustrative example, display environment 100 in FIG. 1 is depicted in block form to illustrate different components for one or more illustrative embodiments. Display environment 100 may include banner 102, plurality of mounting fixtures 104, and plurality of rods 106. Banner 102 may be hung from building 108 using plurality of mounting fixtures 104. Plurality of mounting fixtures 104 may include mounting fixture 109. Mounting fixture 109 may include clamping mechanism 110, shaft 112, and head 114. Clamping mechanism 110 may have coarse adjustment 116, fine adjustment 118, first surface 120, and second surface 122. Coarse adjustment 116 may be used to adjust a position of second surface 122 relative to shaft 112.

Second surface 122 of clamping mechanism 110 may travel along shaft 112. By moving second surface 122 along shaft 112, distance 123 between first surface 120 and second surface 122 may be changed. For example, as second surface 122 moves towards first end 124 of shaft 112, distance 123 between first surface 120 and second surface 122 may decrease. As second surface 122 moves toward second end 126 of shaft 112, distance 123 between first surface 120 and second surface 122 may increase.

Coarse adjustment 116 may also move fine adjustment 118 along shaft 112 as coarse adjustment 116 adjusts the position of second surface 122 along shaft 112. In some illustrative examples, coarse adjustment 116 may take the form of a lock 127 associated with arm 128 of clamping mechanism 110.

When one component is “associated” with another component, the association is a physical association in the depicted examples. For example, a first component may be considered to be associated with a second component by being secured to the second component, bonded to the second component, mounted to the second component, welded to the second component, fastened to the second component, and/or connected to the second component in some other suitable manner. The first component also may be connected to the second component using a third component. The first component may also be considered to be associated with the second component by being formed as part of and/or an extension of the second component.

Lock 127 may be associated with arm 128 and shaft 112. By releasing lock 127, arm 128 may travel along shaft 112. Second surface 122 may be either directly or indirectly connected to arm 128. In these examples, second surface 122 may travel along shaft 112 with arm 128 as arm 128 travels along shaft 112.

Fine adjustment 118 may move second surface 122 relative to first surface 120. Fine adjustment 118 may move second surface 122 towards or away from first surface 120. Fine adjustment 118 may move second surface 122 in smaller increments than coarse adjustment 116.

In some illustrative examples, second surface 122 may be a component of fine adjustment 118. In some illustrative examples, second surface 122 may be connected to fine adjustment 118.

In some illustrative examples, fine adjustment 118 may take the form of a screw clamp. By adjusting a screw of fine adjustment 118, second surface 122 may move relative to first surface 120.

In some illustrative examples, first surface 120 may be associated with head 114. Head 114 may be associated with first end 124 of shaft 112. Head 114 may be formed of any desirable material. In some illustrative examples, head 114 may be formed of a metal. Head 114 may have number of channels 130 and hook 131. As used herein, “a number of” when used with reference to items means one or more items. In some illustrative examples, head 114 may be a single monolithic component. For example, head 114 including number of channels 130 may be diecast as a single component. In other illustrative examples, head 114 may be formed by connecting separate components including at least one of number of channels 130 or hook. For example, head 114 may be formed by welding number of channels 130 to at least one other component of head 114.

At least one rod of plurality of rods 106 may be inserted into number of channels 130. Number of channels 130 may include any desirable number of channels. As depicted, number of channels 130 may include channel 132 and channel 134. Channel 132 may have insert 136 and retainer 138.

Insert 136 may be formed of a different material than channel 132. In some illustrative examples, insert 136 may be formed of a polymeric material. Insert 136 may change the diameter of channel 132. Insert 136 may prevent damage to either channel 132 or plurality of rods 106. For example, when insert 136 is formed of a polymeric material, insert 136 may have lower friction with first rod 139 of plurality of rods 106 than the friction between channel 132 and a rod of plurality of rods 106.

Retainer 138 may retain first rod 139 of plurality of rods 106 within channel 132. Retainer 138 may apply pressure to first rod 139 of plurality of rods 106 to retain first rod 139 within channel 132. By applying pressure to first rod 139 of plurality of rods 106, retainer 138 may pressure first rod 139 against at least one of insert 136 or channel 132. As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C or item B and item C. The item may be a particular object, thing, or a category. In other words, at least one of means any combination of items and number of items may be used from the list but not all of the items in the list are required.

In some illustrative examples, retainer 138 may take the form of screw 140. To apply pressure to first rod 139, screw 140 may contact first rod 139.

Channel 134 may have insert 142 and retainer 144. Insert 142 may be formed of a different material than channel 134. In some illustrative examples, insert 142 may be formed of a polymeric material. Insert 142 may change the diameter of channel 134. Insert 142 may prevent damage to either channel 134 or plurality of rods 106. For example, when insert 142 is formed of a polymeric material, insert 142 may have lower friction with second rod 145 of plurality of rods 106 than the friction between channel 134 and a rod of plurality of rods 106.

Retainer 144 may retain second rod 145 of plurality of rods 106 within channel 134. Retainer 144 may apply pressure to second rod 145 of plurality of rods 106 to retain second rod 145 within channel 134. By applying pressure to second rod 145 of plurality of rods 106, retainer 144 may pressure second rod 145 against at least one of insert 142 or channel 134. In some illustrative examples, retainer 144 may take the form of screw 146. To apply pressure to second rod 145, screw 146 may contact second rod 145.

Mounting fixture 109 may be used to hang banner 102. Banner 102 may have display surface 148, surface 150, and length 152. Surface 150 may be an opposite surface to display surface 148. In some illustrative examples, surface 150 may also be referred to as a back surface.

Grommets 154 may extend through display surface 148 and surface 150. Banner 102 may be hung using grommets 154. Hook 131 of mounting fixture 109 may extend through first grommet 156 of banner 102. Hook 157 of mounting fixture 158 may extend through second grommet 160 of banner 102. Although mounting fixture 158 is only depicted as having hook 157 and channel 162, mounting fixture 158 may have substantially the same design as mounting fixture 109. In this illustrative example, banner 102 may hang from hook 131 and hook 157.

In some illustrative examples, mounting fixture 109 and mounting fixture 158 may clamp onto ridge 164 of building 108. For example, mounting fixture 109 may be clamped onto ridge 164 using clamping mechanism 110. When mounting fixture 109 is clamped onto ridge 164, first surface 120 and second surface 122 may contact ridge 164. In some illustrative examples, ridge 164 may be associated with roof 165 of building 108.

When mounting fixture 109 and mounting fixture 158 are clamped onto ridge 164, banner 102 may be hung on hook 131 and hook 157. To secure banner 102 against wind 166, plurality of rods 106 may extend into plurality of pockets 167. Plurality of pockets 167 may include first pocket 168, second pocket 169, and third pocket 170. In some illustrative examples, first rod 139 may extend through channel 132 and into first pocket 168. In some illustrative examples, second rod 145 may extend through channel 134 and into second pocket 169. In some illustrative examples, third rod 171 of plurality of rods 106 may extend through channel 162 of mounting fixture 158 and into third pocket 170.

By placing plurality of rods 106 into plurality of pockets 167, banner 102 may be secured against wind 166. In some illustrative examples, each of plurality of pockets 167 may contain a respective rod of plurality of rods 106. In some illustrative examples, only a subset of plurality of pockets 167 may contain a respective rod of plurality of rods 106.

Plurality of pockets 167 may be positioned relative to grommets 154. In some illustrative examples, each grommet of grommets 154 may be positioned relative to a single pocket of plurality of pockets 167. In some illustrative examples, each grommet of grommets 154 may be associated with two pockets of plurality of pockets 167.

In some illustrative examples, plurality of pockets 167 may extend along length 152 of banner 102. In some illustrative examples, plurality of pockets 167 may extend only a portion of length 152 of banner 102. In one illustrative example, plurality of pockets 167 may begin below grommets 154. For example, plurality of pockets 167 may begin between about 1 inch and about 2 inches below grommets 154. By beginning plurality of pockets 167 below grommets 154, banner 102 may be more flexible for hanging on hook 131 and hook 157. In other words, by beginning plurality of pockets 167 below grommets 154, hanging banner 102 onto hook 131 and hook 157 may not be too tight. If banner 102 includes bottom grommets, plurality of pockets 167 may extend to about the location of the bottom grommets.

In some illustrative examples first pocket 168 may have taper 172. Taper 172 may be a reduction in width of first pocket 168 from top 173 of banner 102 to bottom 174 of banner 102. Taper 172 may retain first rod 139 within first pocket 168. Further, taper 172 may add stability to first rod 139. By adding stability to first rod 139, taper 172 may improve resistance to wind 166. Further, taper 172 may improve the aesthetics of banner 102 by allowing banner 102 to hang tighter.

Although only first pocket 168 is depicted as having taper 172, in some illustrative examples, other pockets of plurality of pockets 167 may also be tapered. For example, in some illustrative examples, second pocket 169 and third pocket 170 may also be tapered.

Plurality of rods 106 may be formed of any desired material to provide material properties 176. Material properties 176 may be desirable for securing banner 102 against wind 166. Material properties 176 may include strength 178 and flexibility 180. Strength 178 may be such that plurality of rods 106 may protect banner 102 from wind 166. Flexibility 180 may be such that plurality of rods 106 may not rip through banner 102 when wind 166 interacts with banner 102. The material of plurality of rods 106 may be selected for other desirable criteria. For example, the material for plurality of rods 106 may be selected based on at least one of machinability, cost, or other desirable factors. In some illustrative examples, plurality of rods 106 may be formed of at least one of fiberglass 182 or metal 184.

Cross-sectional shape 186 of plurality of rods 106 may be selected such that plurality of rods 106 may fit within plurality of pockets 167. Cross-sectional shape 186 of plurality of rods 106 may be selected such that plurality of rods 106 may fit within number of channels 130. In some illustrative examples, cross-sectional shape 186 of plurality of rods 106 may be one of substantially circular, ovular, triangular, square, or any other desirable shape.

Length 188 of plurality of rods 106 is sufficient to extend through number of channels 130 and into plurality of pockets 167. In some illustrative examples, length 188 of plurality of rods 106 may be sufficient for plurality of rods 106 to extend out of number of channels 130 a sufficient length for a user to grasp and remove plurality of rods 106 from number of channels 130. In some illustrative examples, length 188 of plurality of rods 106 may be greater than length 152 of banner 102.

In some illustrative examples, mounting fixture 109 may optionally include stabilizer bar 192. Stabilizer bar 192 may substantially reduce movement of mounting fixture relative to structure 190 when mounting fixture 109 is secured to structure 190. Specifically, stabilizer bar 190 may reduce rotation of mounting fixture 109 about an axis extending through first surface 120 and second surface 122 when mounting fixture 109 is secured to structure 190. Stabilizer bar 192 may be associated with at least one of shaft 112 or head 114 of mounting fixture 109. In some illustrative examples, stabilizer bar 192 may take the form of an L-shaped bar. Stabilizer bar 192 may be formed of any desirable material. The material for stabilizer bar 192 may be selected such that stabilizer bar 192 has a desirable strength. In some illustrative examples, stabilizer bar 192 may be formed of a metal or metal alloy.

In some illustrative examples, when mounting fixture 109 has stabilizer bar 192, first surface 120 may not contact structure 190 during clamping. In other illustrative examples, when mounting fixture 109 is clamped to structure 190, each of first surface 120, second surface 122, and stabilizer bar 192 may contact structure 190.

In some illustrative examples, display environment 100 may optionally include bottom straighteners 194. Bottom straighteners 194 may interact with grommets 154 of banner 102. Bottom straighteners 194 may provide a rigidity at bottom 174 of banner 102. Bottom straighteners 194 may reduce curling of bottom 174 of banner 102.

The illustration of display environment 100 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although plurality of rods 106 are shown as having first rod 139, second rod 145, and third rod 171, plurality of rods 106 may have any desirable number of rods. In some illustrative examples, plurality of rods 106 may only include two rods. In some illustrative examples, plurality of rods 106 may include more than three rods.

As another example, although first rod 139 and second rod 145 are described as extending through number of channels 130 of mounting fixture 109, in some illustrative examples only first rod 139 may extend through mounting fixture 109. Second rod 145 may instead extend through channel 162 of mounting fixture 158 or any other desirable channel of plurality of mounting fixtures 104.

As yet a further example, although mounting fixture 109 is described as having channel 132 and channel 134, in some illustrative examples, number of channels 130 may instead include only a single channel. Although mounting fixture 158 is illustrated as having only channel 162, mounting fixture 158 may have any desirable number of channels. In some illustrative examples, mounting fixture 158 may have substantially the same design as mounting fixture 109.

As yet a further example, although display environment 100 is depicted as having building 108, in some illustrative examples, banner 102 may be hung from structure 190. Structure 190 may take the form of a fence, a billboard, a door, a lamppost, or any other desirable type of structure. A portion of structure 190 may be clamped by clamping mechanism 110 of mounting fixture 109 to secure mounting fixture 109 to structure 190.

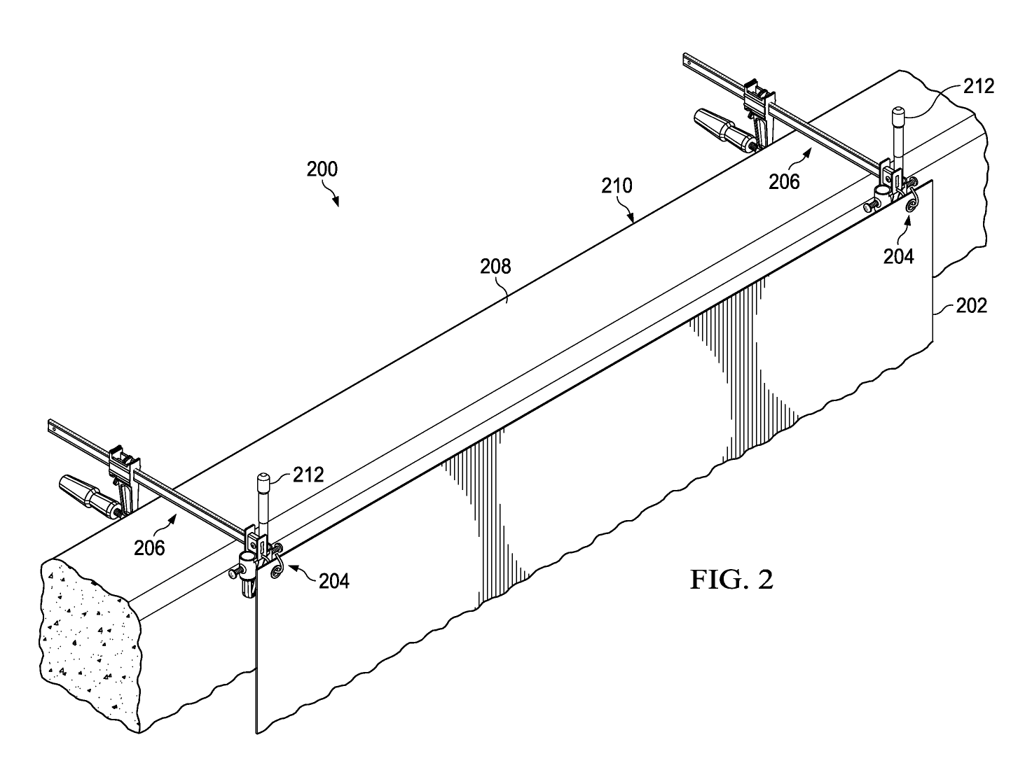

Turning now to FIG. 2, an illustration of an isometric view of a plurality of mounting fixtures holding a banner for display is depicted in accordance with an illustrative embodiment. Display environment 200 may be a physical implementation of display environment 100. As depicted, banner 202 may hang from hooks 204 of plurality of mounting fixtures 206. Plurality of mounting fixtures 206 may be a physical implementation of plurality of mounting fixtures 104. Plurality of mounting fixtures 206 may be clamped onto ridge 208 of building 210. Plurality of rods 212 extend through plurality of mounting fixtures 206 and into a plurality of pockets (not depicted) of banner 202.

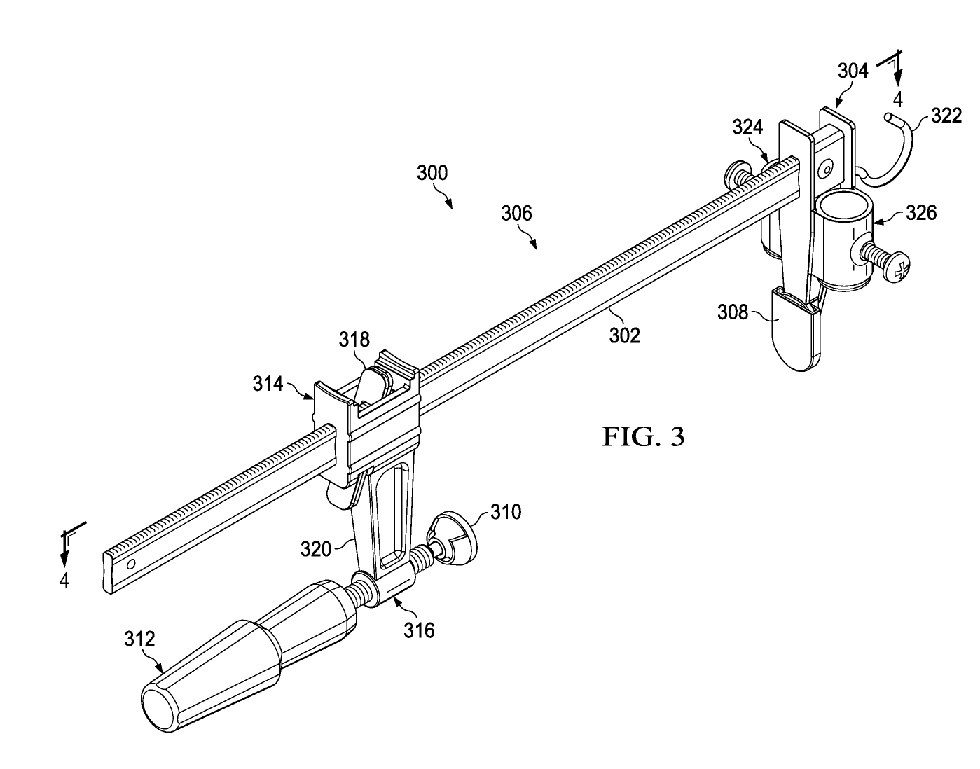

Turning now to FIG. 3, an illustration of an isometric view of a mounting fixture is depicted in accordance with an illustrative embodiment. Mounting fixture 300 may be a physical implementation of mounting fixture 109 of FIG. 1. Mounting fixture 300 may be one of plurality of mounting fixtures 206 of FIG. 2.

Mounting fixture 300 may include shaft 302, head 304, and clamping mechanism 306. Clamping mechanism 306 includes first surface 308, second surface 310, fine adjustment 312, and coarse adjustment 314. As depicted, first surface 308 is a part of head 304. As depicted, second surface 310 is a part of fine adjustment 312. Fine adjustment 312 takes the form of screw clamp 316. Screw clamp 316 may move second surface 310 towards or away from first surface 308.

As depicted, coarse adjustment 314 takes the form of lock 318 associated with arm 320. By releasing lock 318, arm 320 may be moved along shaft 302. By moving arm 320 along shaft 302, second surface 310 may move towards or away from first surface 308.

Clamping mechanism 306 may secure mounting fixture 300 to a structure such as ridge 164 of FIG. 1. A banner, such as banner 102 of FIG. 1, may be hung from hook 322 of clamping mechanism 306. A rod, such as first rod 139 of FIG. 1 may extend through one of channel 324 or channel 326. In some illustrative examples, a second rod may extend through the other of channel 324 or channel 326. As depicted, each of hook 322, channel 324, and channel 326 are associated with head 304.

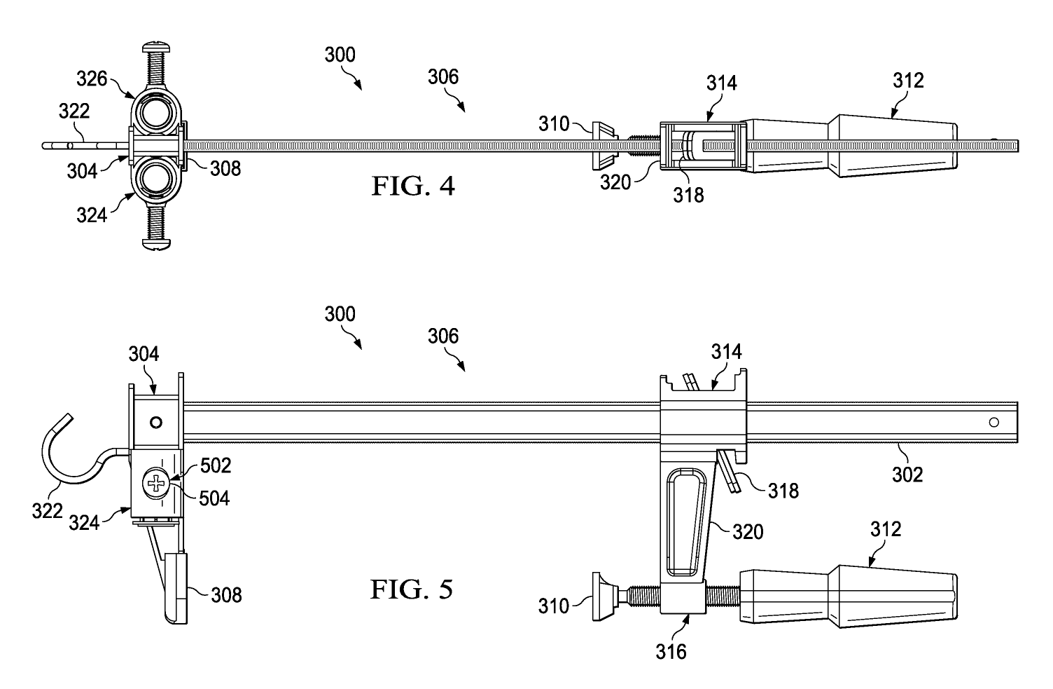

Turning now to FIG. 4, an illustration of a top view of a mounting fixture is depicted in accordance with an illustrative embodiment. View 400 may be a view of mounting fixture 300 from direction 4 of FIG. 3. Channel 324 and channel 326 may be seen more clearly in view 400. Further, insert 402 within channel 324 and insert 404 within channel 326 may be seen in view 400.

Turning now to FIG. 5, an illustration of a side view of a mounting fixture is depicted in accordance with an illustrative embodiment. View 500 may be a view of mounting fixture 300 from direction 5 of FIG. 4. Retainer 502 may be seen in view 500. Retainer 502 may retain a rod within channel 324 of mounting fixture 300 of FIG. 3. In this illustrative example, retainer 502 takes the form of screw 504 which may be actuated to retain a rod within channel 324 of mounting fixture 300.

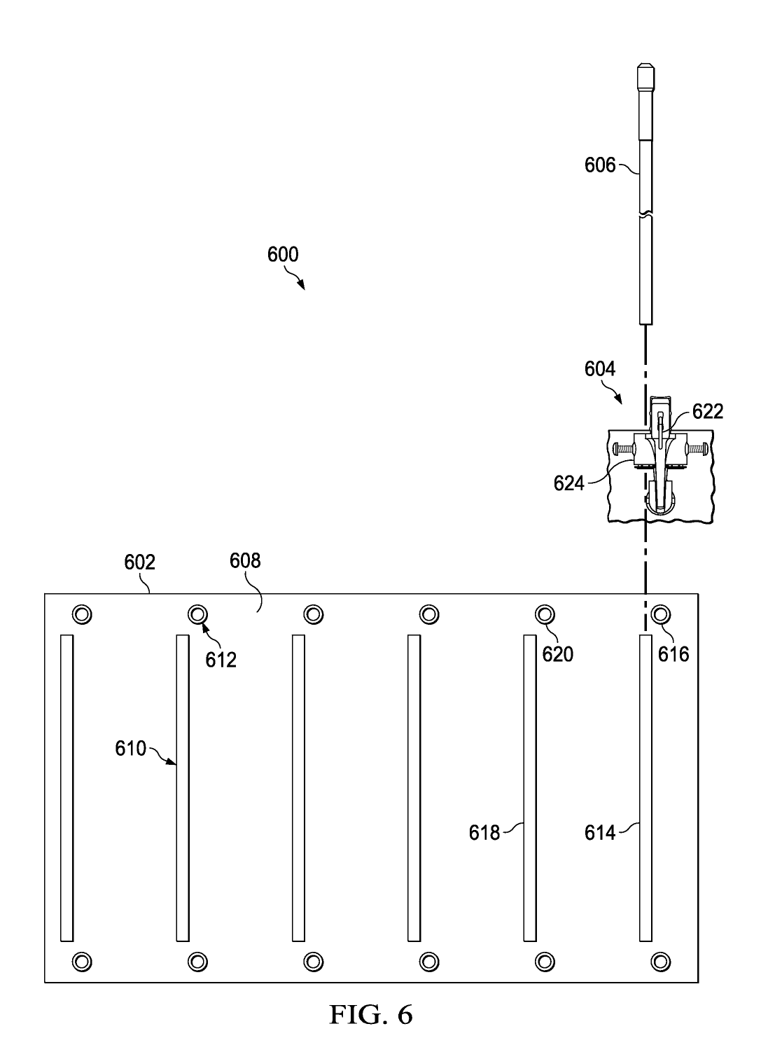

Turning now to FIG. 6, an illustration of an exploded back view of a rod, mounting fixture, and banner is depicted in accordance with an illustrative embodiment. View 600 may be an exploded view of components of display environment 200 of FIG. 2. View 600 includes banner 602, mounting fixture 604, and rod 606. In view 600, surface 608 is visible. Surface 608 may also be referred to as a back surface. Surface 608 has plurality of pockets 610. Each of plurality of pockets 610 is positioned relative to a grommet of grommets 612. For example, first pocket 614 is positioned relative to first grommet 616 of grommets 612. In this illustrative example, first pocket 614 is offset from first grommet 616. First pocket 614 may be offset based on the design of mounting fixture 604. Second pocket 618 is positioned relative to second grommet 620 of grommets 612. Each pocket of plurality of pockets 610 is only positioned relative to a single grommet of grommets 612. In this illustrative example, each grommet of grommets 612 is associated with only one pocket of plurality of pockets 610.

To hang banner 602, first grommet 616 may be hung onto hook 622 of mounting fixture 604. To secure banner 602 against wind, rod 606 may be inserted through channel 624 of mounting fixture 604 and into first pocket 614.

Although only a single mounting fixture, mounting fixture 604, is depicted, a plurality of mounting fixtures may be used to hang and secure banner 602. Further, although mounting fixture 604 is depicted with two channels, mounting fixture 604 may instead have only a single channel. Yet further, although as depicted each grommet of grommets 612 is positioned relative to a single pocket, at least one grommet of grommets 612 may be positioned relative to with more than one pocket. In some illustrative examples, at least one grommet of grommets 612 may not be positioned relative to a pocket. In some illustrative examples, at least one grommet of grommets 612 may be associated with a different number of pockets than other grommets of grommets 612.

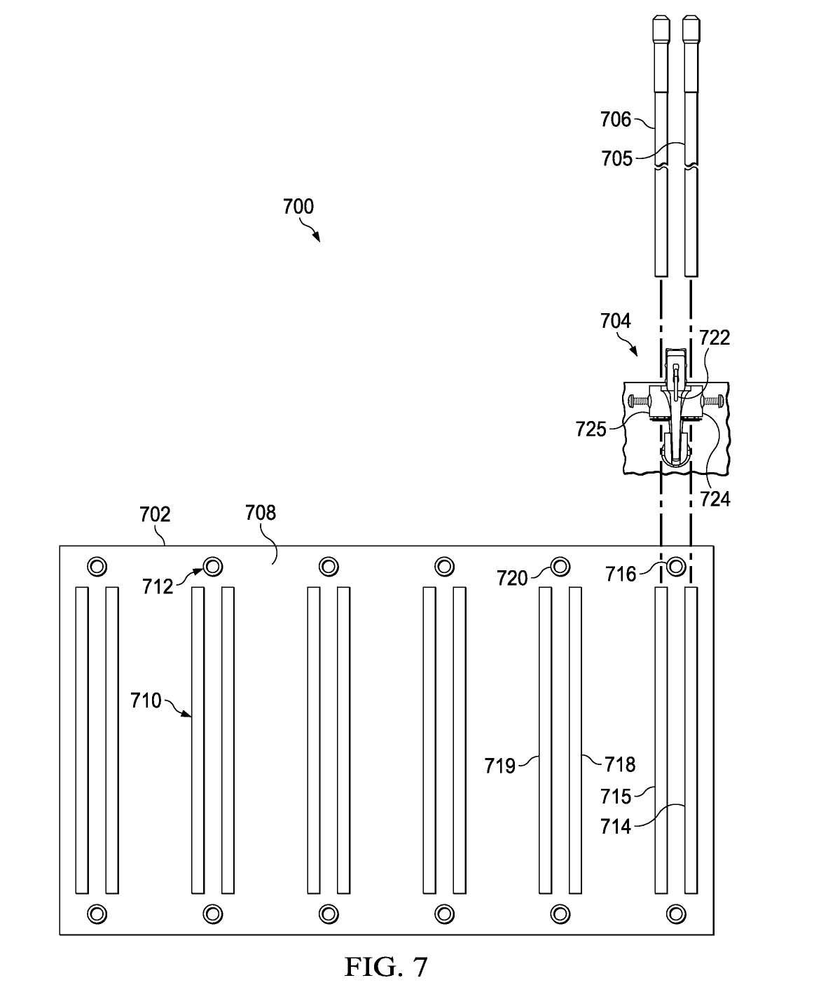

Turning now to FIG. 7, an illustration of an exploded back view of a rod, mounting fixture, and banner is depicted in accordance with an illustrative embodiment. View 700 may be an exploded view of components of display environment 200 of FIG. 2. View 700 includes banner 702, mounting fixture 704, rod 705, and rod 706. In view 700, surface 708 is visible. Surface 708 may also be referred to as a back surface. Surface 708 has plurality of pockets 710. Each of plurality of pockets 710 is positioned relative to a grommet of grommets 712. For example, first pocket 714 and second pocket 715 are positioned relative to first grommet 716 of grommets 712. Third pocket 718 and fourth pocket 719 are positioned relative to second grommet 720 of grommets 712. Each pocket of plurality of pockets 710 is only positioned relative to a single grommet of grommets 712. In this illustrative example, each grommet of grommets 712 is associated with two pockets of plurality of pockets 710.

To hang banner 702, first grommet 716 may be hung onto hook 722 of mounting fixture 704. To secure banner 702 against wind, rod 705 may be inserted through channel 724 of mounting fixture 704 and into first pocket 714. To secure banner 702 against wind, rod 706 may be inserted through channel 725 of mounting fixture 704 and into second pocket 715.

Although only a single mounting fixture, mounting fixture 704, is depicted, a plurality of mounting fixtures may be used to hang and secure banner 702. Further, although each grommet of grommets 712 is depicted as positioned relative to two pockets, at least one of grommets 712 may be associated with less than two pockets.

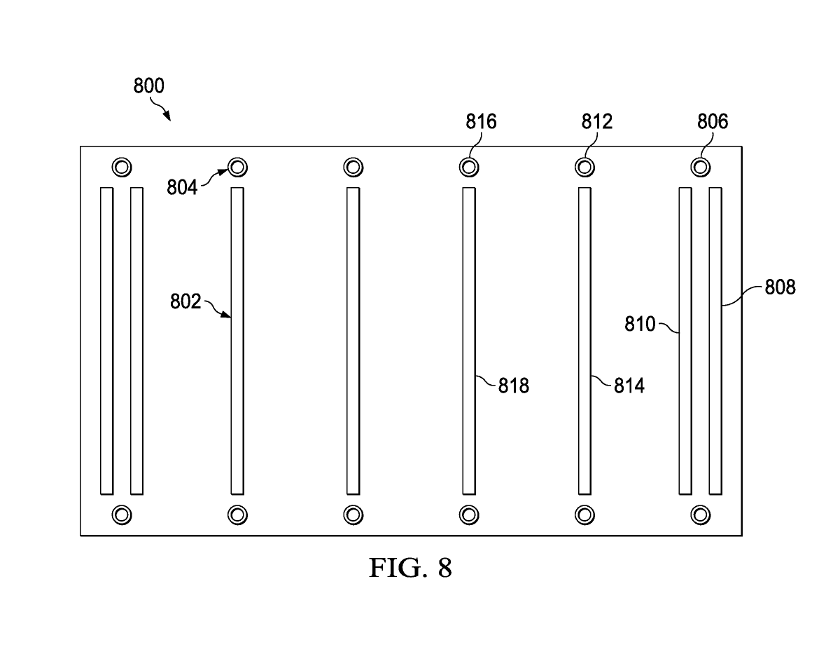

Turning now to FIG. 8, an illustration of a back view of a banner is depicted in accordance with an illustrative embodiment. In this illustrative example, banner 800 has plurality of pockets 802 and grommets 804. In this illustrative example, some of grommets 804 are associated with a different number of plurality of pockets 802 than others of grommets 804. For example, first grommet 806 is associated with first pocket 808 and second pocket 810. Second grommet 812 is associated with third pocket 814. Third grommet 816 is associated with fourth pocket 818.

As depicted, third pocket 814 is centered with second grommet 812. As depicted, fourth pocket 818 is centered with third grommet 816. As a result, the mounting fixtures used to hang second grommet 812 and third grommet 816 may each have a channel centered relative to a hook of the respective mounting fixture. As a result, the mounting fixtures used to hang second grommet 812 and third grommet 816 may have a different design than mounting fixtures used to hang banner 800 using first grommet 806 and fourth pocket 818.

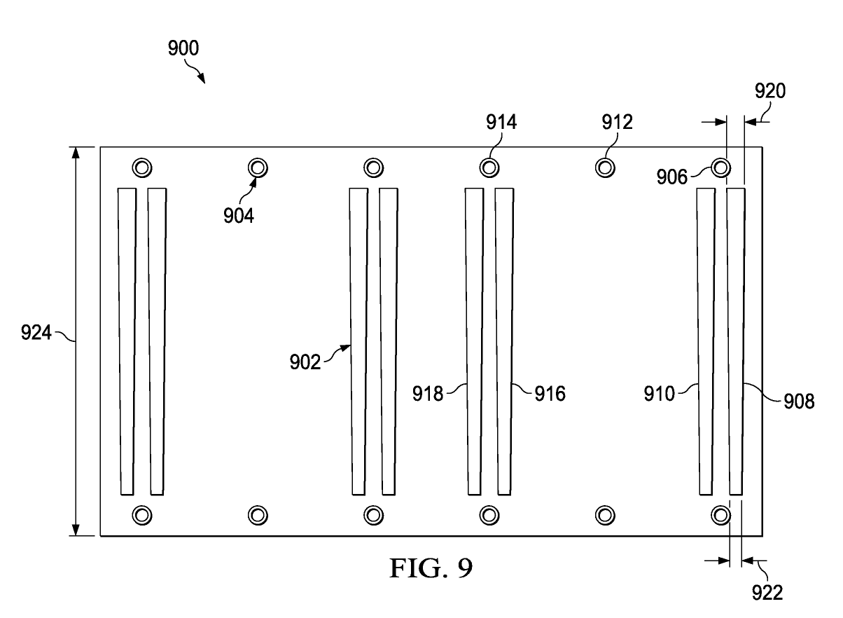

Turning now to FIG. 9, an illustration of a back view of a banner is depicted in accordance with an illustrative embodiment. In this illustrative example, banner 900 has plurality of pockets 902 and grommets 904. In this illustrative example, some of grommets 904 are not associated with any of plurality of pockets 902. For example, first grommet 906 is associated with first pocket 908 and second pocket 910. Second grommet 912 is not associated with a pocket. Third grommet 914 is associated with third pocket 916 and fourth pocket 918.

As depicted, each pocket of plurality of pockets 902 is tapered. For example, first pocket 908 has first width 920 and second width 922. First width 920 is closer to first grommet 906. First width 920 is larger than second width 922. Thus, first pocket 908 tapers along length 924 of banner 900.

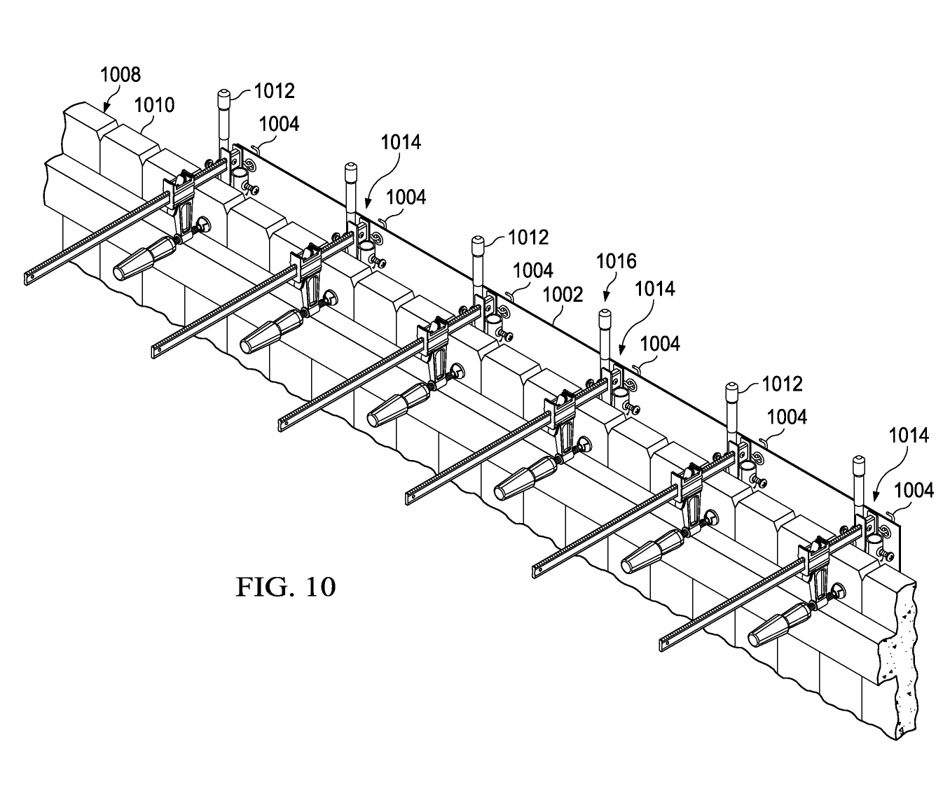

Turning now to FIG. 10, an illustration of a back isometric view of a plurality of mounting fixtures holding a banner for display is depicted in accordance with an illustrative embodiment. Display environment 1000 may be a physical implementation of display environment 200 of FIG. 2. As can be seen in display environment 1000, banner 1002 may hang from hooks 1004 of plurality of mounting fixtures 1006. Plurality of mounting fixtures 1006 may be a physical implementation of plurality of mounting fixtures 104. Plurality of mounting fixtures 1006 may be clamped onto structure 1008. Structure 1008 may take the form of fence 1010. Plurality of rods 1012 extend through plurality of mounting fixtures 1006 and into a plurality of pockets (not depicted) of banner 1002.

Plurality of rods 1012 extends past plurality of heads 1014 of plurality of mounting fixtures 1006. Lengths 1016 of plurality of rods 1012 may be sufficient to extend past plurality of heads 1014 so that a user may easily remove plurality of rods 1012 from plurality of mounting fixtures 1006. Lengths 1016 of plurality of rods 1012 may be selected such that plurality of rods 1012 to not extend an undesirable distance above fence 1010. If lengths of 1004 of plurality of rods 1012 were an undesirable distance above fence 1010, plurality of rods 1012 may be aesthetically displeasing. If lengths of 1004 of plurality of rods 1012 were an undesirable distance above fence 1010, plurality of rods 1012 may be undesirably acted upon by wind above fence 1010.

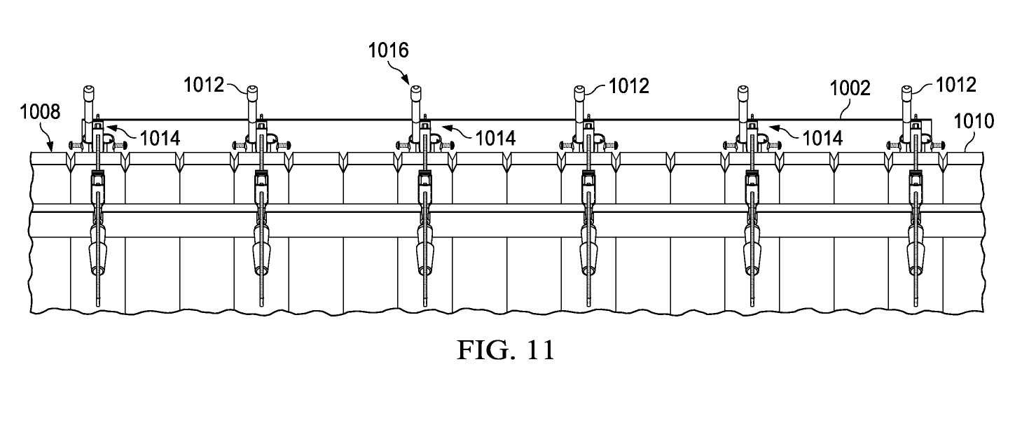

Turning now to FIG. 11, an illustration of a back view of a plurality of mounting fixtures holding a banner for display is depicted in accordance with an illustrative embodiment. View 1100 may be a view of display environment 1000 from direction 11 of FIG. 10.

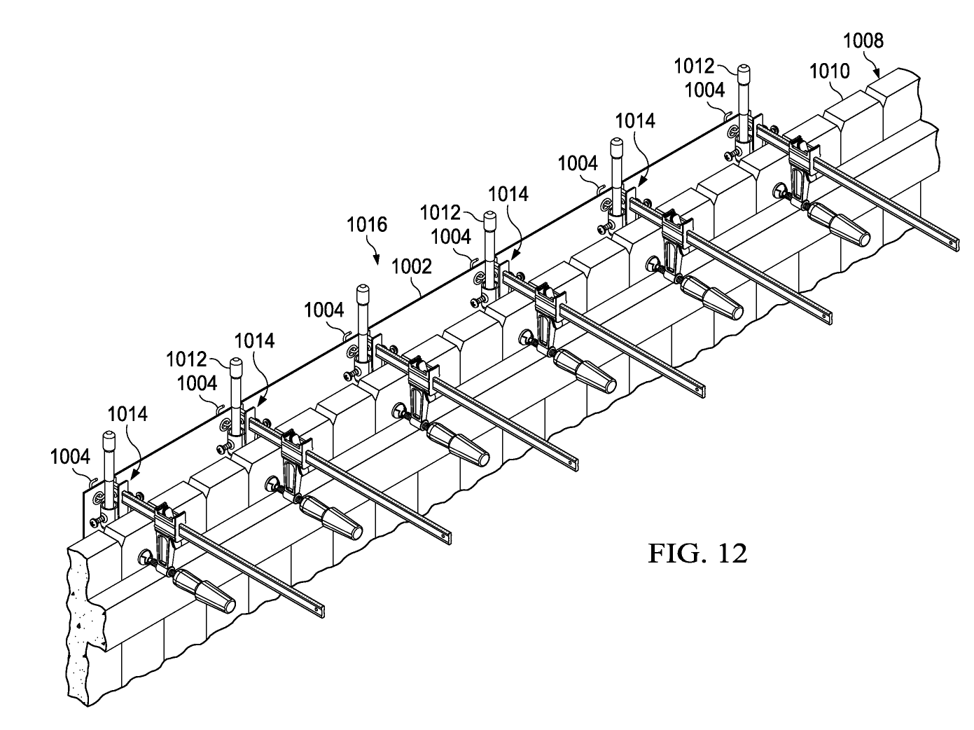

Turning now to FIG. 12, an illustration of a back isometric view of a plurality of mounting fixtures holding a banner for display is depicted in accordance with an illustrative embodiment. View 1200 may be a view of display environment 1000 from direction 12 of FIG. 11.

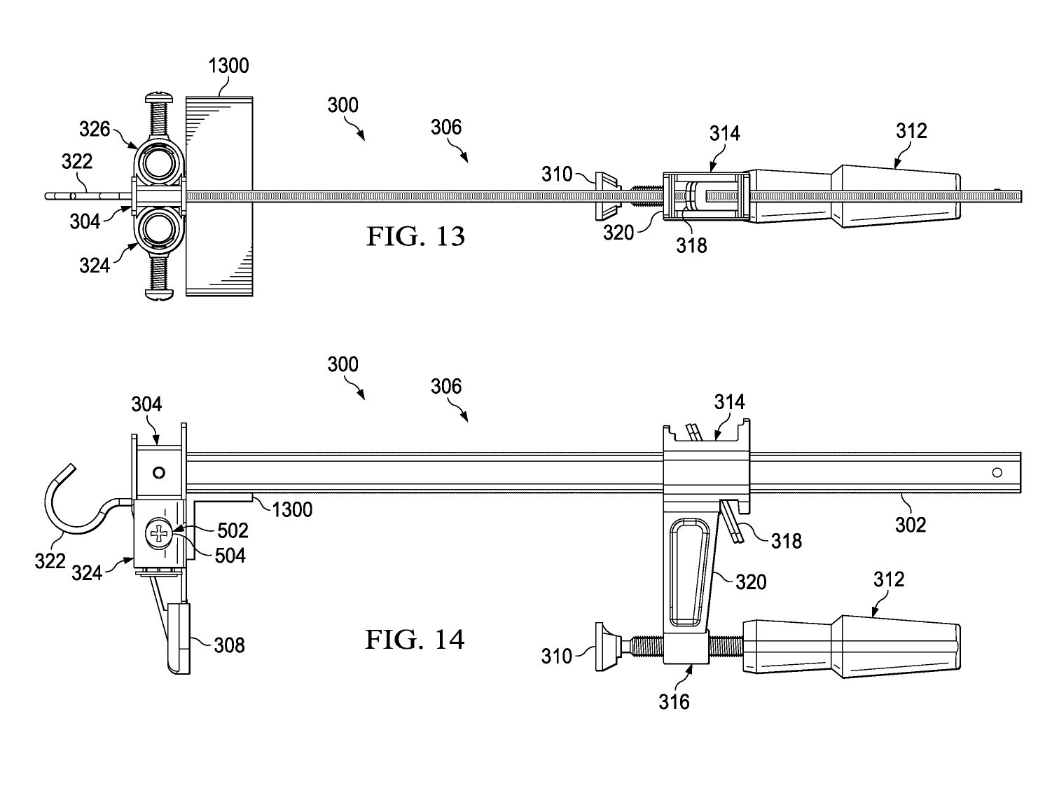

Turning now to FIG. 13, an illustration of a top view of a mounting fixture is depicted in accordance with an illustrative embodiment. In FIG. 13, stabilizer bar 1300 has been added to mounting fixture 300 of FIGS. 3-6. When mounting fixture 300 is clamped to a structure, stabilizer bar 1300 may contact the structure. Stabilizer bar 1300 may reduce movement of mounting fixture 300 when mounting fixture 300 is clamped to the structure.

Turning now to FIG. 14, an illustration of a side view of a mounting fixture is depicted in accordance with an illustrative embodiment. As can be seen in FIG. 14, stabilizer bar 1300 may have a L-shaped cross-section.

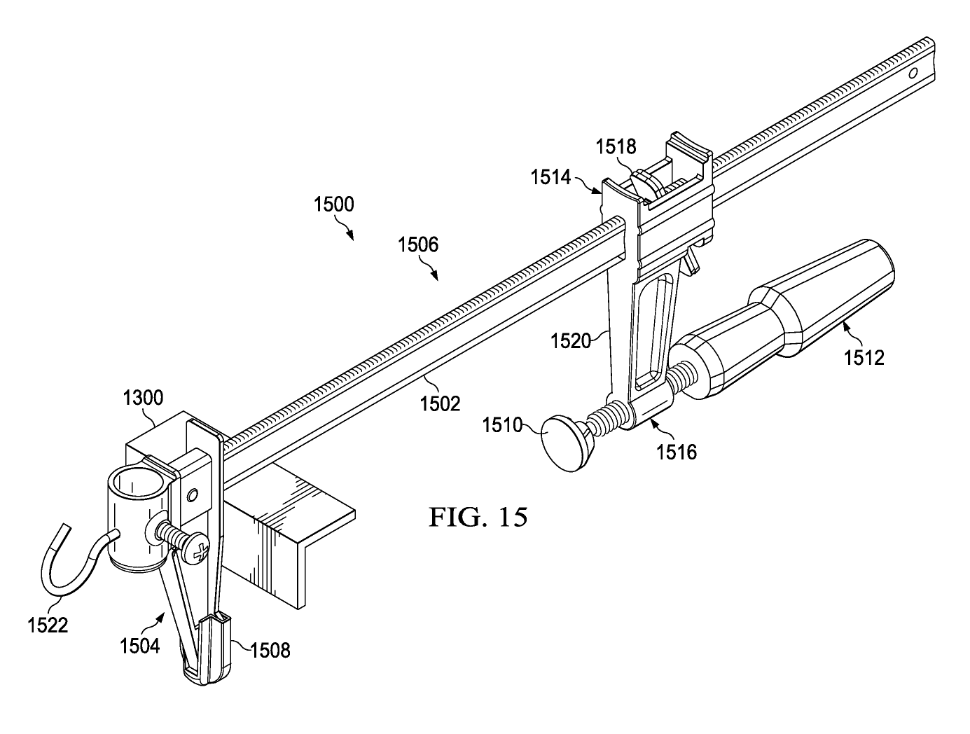

Turning now to FIG. 15, an illustration of An isometric view of another mounting fixture is depicted in accordance with an illustrative embodiment. Mounting fixture 1500 may include shaft 1502, head 1504, and clamping mechanism 1506. Clamping mechanism 1506 includes first surface 1508, second surface 1510, fine adjustment 1512, and coarse adjustment 1514. As depicted, first surface 1508 is a part of head 1504. As depicted, second surface 1510 is a part of fine adjustment 1512. Fine adjustment 1512 takes the form of screw clamp 1516. Screw clamp 1516 may move second surface 1510 towards or away from first surface 1508.

As depicted, coarse adjustment 1514 takes the form of lock 1518 associated with arm 1520. By releasing lock 1518, arm 1520 may be moved along shaft 1502. By moving arm 1520 along shaft 1502, second surface 1510 may move towards or away from first surface 1508.

Clamping mechanism 1506 may secure mounting fixture 1500 to a structure such as ridge 164 of FIG. 1. A banner, such as banner 102 of FIG. 1, may be hung from hook 1522 of clamping mechanism 1506. A rod, such as first rod 159 of FIG. 1 may extend through channel 1524. As depicted, head 1504 is only associated with a single channel. Channel 1524 may be centered relative to shaft 1502. As a result, a rod extending through channel 1524 may be centered relative to hook 1522. In FIGS. 3-6, a rod extending through channel 324 may not be centered relative to hook 1322.

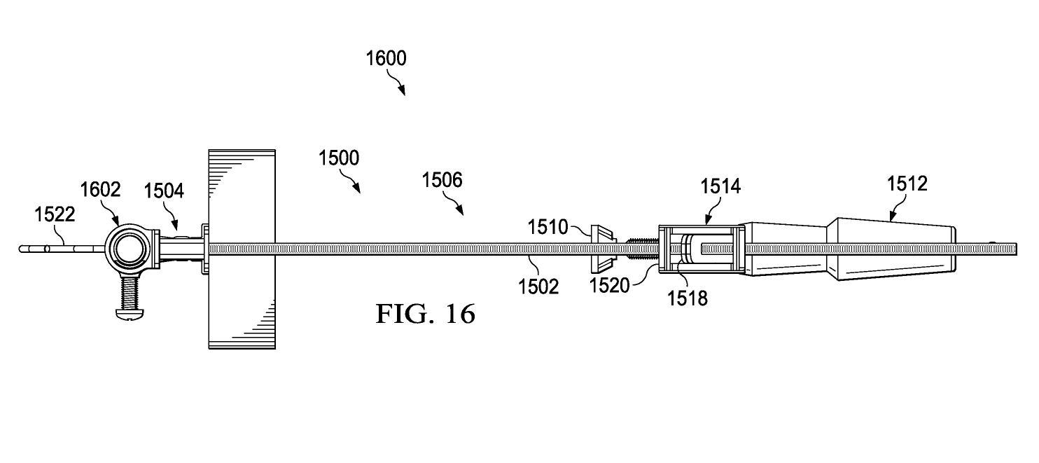

Turning now to FIG. 16, an illustration of a top view of a mounting fixture is depicted in accordance with an illustrative embodiment. View 1600 may be a view of mounting fixture 1500 from direction 16 of FIG. 15. Channel 1524 may be seen more clearly in view 1600. Further, insert 1602 within channel 1524 may be seen in view 1600.

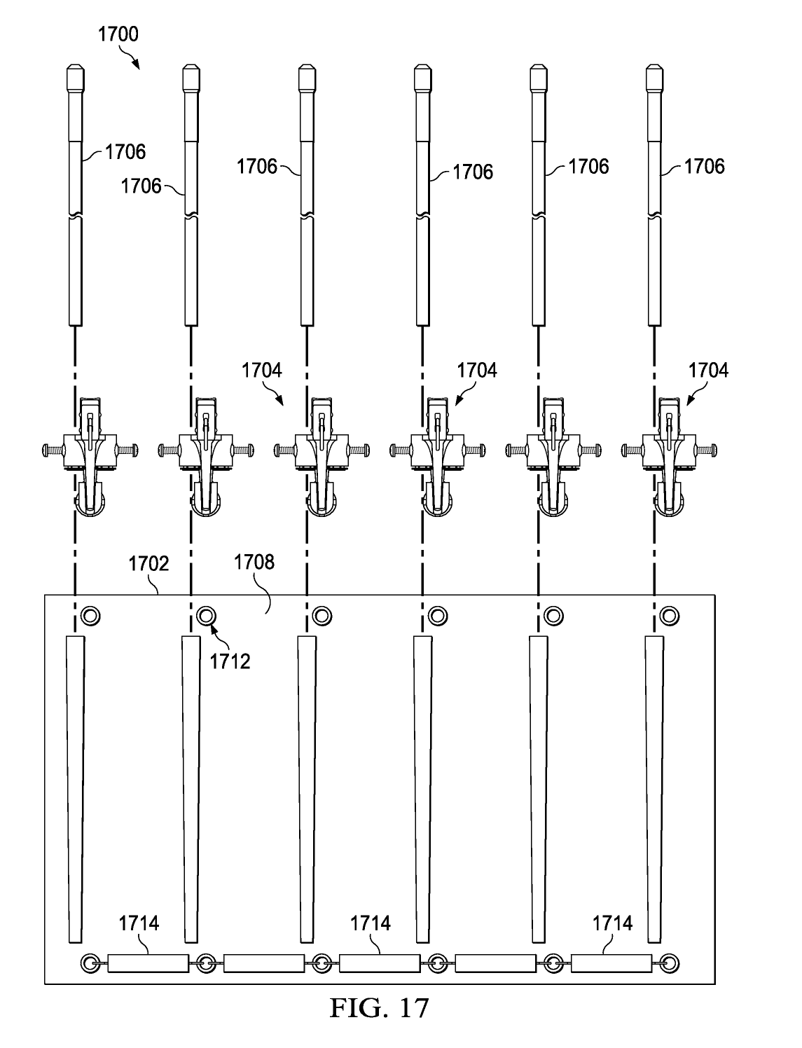

Turning now to FIG. 17, an illustration of an exploded back view of a plurality of rods, a plurality of mounting fixtures, banner, and a plurality of bottom straighteners is depicted in accordance with an illustrative embodiment. View 1700 may be an exploded view of components of display environment 200 of FIG. 2. View 1700 includes banner 1702, mounting fixtures 1704, and rods 1706. In view 1700, surface 1708 is visible. Surface 1708 may also be referred to as a back surface. Surface 1708 has plurality of pockets 1710. Each of plurality of pockets 1710 is positioned relative to a grommet of grommets 1712. Each pocket of plurality of pockets 1710 is only positioned relative to a single grommet of grommets 1712. In this illustrative example, each grommet of grommets 1712 is associated with only one pocket of plurality of pockets 1710.

In this illustrative example, bottom straighteners 1714 are used in connection with grommets 1712. Each bottom straightener of bottom straighteners 1714 may be placed into two grommets of grommets 1712. Bottom straighteners 1714 may stiffen the bottom of banner 1702. Bottom straighteners 1714 may prevent or reduce curling of the bottom of banner 1702.

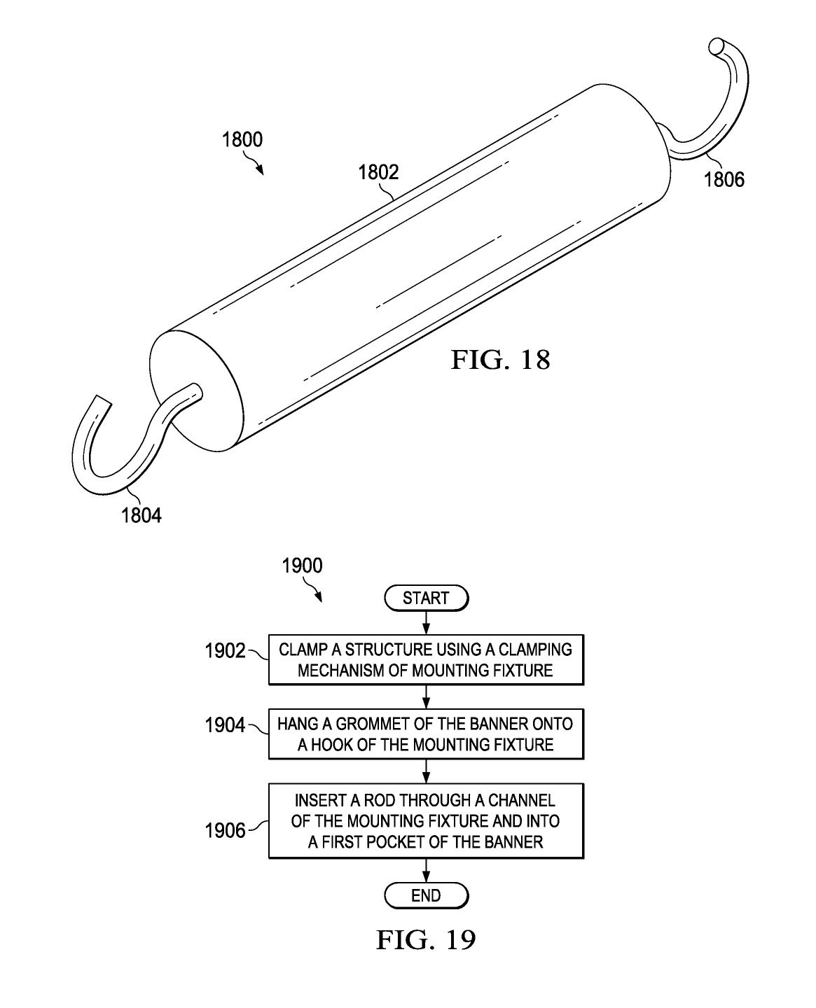

Turning now to FIG. 18, an illustration of an isometric view of a bottom straightener is depicted in accordance with an illustrative embodiment. Bottom straightener 1800 may be a bottom straightener of bottom straighteners 1714 in FIG. 17. Bottom straightener 1800 may be a physical implementation of a bottom straightener of bottom straighteners 194 in FIG. 1. Bottom straightener 1800 includes rod 1802, hook 1804, and hook 1806. Hook 1804 and hook 1806 may interact with grommets of a banner to hold bottom straightener 1800 in place relative to the banner. In some illustrative examples, hook 1804 and hook 1806 of bottom straightener 1800 may be inserted into grommets before hanging the banner. In other illustrative examples, hook 1804 and hook 1806 of bottom straightener 1800 may be inserted into grommets after hanging the banner.

The different components shown in FIGS. 2-18 may be combined with components in FIG. 1, used with components in FIG. 1, or a combination of the two. Additionally, some of the components in FIGS. 2-18 may be illustrative examples of how components shown in block form in FIG. 1 can be implemented as physical structures.

Turning now to FIG. 19, an illustration of a flowchart of a process for securing a banner without tying down the bottom of the banner is depicted in accordance with an illustrative embodiment. Process 1900 may be used to secure banner 102 using mounting fixture 109 of FIG. 1.

Process 1900 may be a process of securing a banner without tying down the bottom of the banner. Process 1900 may clamp a structure using a clamping mechanism of mounting fixture (operation 1902). In some illustrative examples, clamping the structure using a clamping mechanism comprises clamping the structure between a first surface and a second surface of the clamping mechanism using at least one of a coarse adjustment or a fine adjustment.

Process 1900 may hang a grommet of the banner onto a hook of the mounting fixture (operation 1904). Process 1900 may insert a rod through a channel of the mounting fixture and into a first pocket of the banner (operation 1906). Afterwards, the process may terminate.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

For example, process 1900 may also activate a retainer to hold the rod in place within the channel. The retainer may take the form of a screw.

In some illustrative examples, process 1900 may also clamp the structure using a second clamping mechanism of a second mounting fixture, hang a second grommet of the banner onto a hook of the second mounting fixture, and insert a second rod through a second channel of the second mounting fixture and into a second pocket of the banner.

In some illustrative examples, process 1900 may instead insert a second rod through a second channel of the mounting fixture and into a second pocket of the banner. A retainer may be actuated to hold the second rod in place within the second channel. The retainer may take the form of a screw.

The illustrative embodiments provide a method and apparatus for securing a banner without tying down the bottom of the banner. A banner may hang from a plurality of mounting fixtures while a plurality of rods extend through the plurality of mounting fixtures and into a plurality of pockets of the banner. To hang a banner, the plurality of mounting fixtures may be clamped to a ridge. A banner may be hung from hooks of the plurality of mounting fixtures. Afterwards, a plurality of rods is inserted through channels of the plurality of mounting fixtures and into the plurality of pockets of the banner. The plurality of rods may be retained within the channels using retainers associated with the channels.

To replace a banner, the retainers may be actuated to release the plurality of rods. The rods may then be removed from the channels and the plurality of pockets. The banner may be removed from the hooks. The plurality of mounting fixtures may remain clamped to the ridge. A new banner may be hung from the hooks. The plurality of rods may then be inserted through the channels and into a plurality of pockets in the new banner. The plurality of rods may then be retained using the retainers.

Securing a banner using the plurality of mounting fixtures and plurality of rods may take less time than securing a banner by tying down bottom grommets of the banner in a conventional method. Further, replacing a banner may be faster using the plurality of mounting fixtures and plurality of rods than if the banner and the new banner were secured by tying down with rope by a conventional method. For example, time may be saved by not having to untie the rope and then retie the rope on the new banner.

Yet further, time and labor may be saved by hanging and securing the banner at the same elevation. For example, a user may clamp the plurality of mounting fixtures, hang the banner, and secure the banner using the plurality of rods all from the roof of a building. As another example, a user may clamp the plurality of mounting fixtures, hang the banner, and secure the banner using the plurality of rods all from a ladder or scaffolding.

Yet further, conventional tying down may interfere with the accessibility of a storefront. For example, conventional tying down may present a tripping hazard. Yet further, conventional tying down may reduce the area a customer may enter the store. The plurality of mounting fixtures and plurality of rods in the illustrative embodiments do not extend past the bottom of the banner while securing the banner. As a result, the plurality of mounting fixtures and plurality of rods may not undesirably affect accessibility of a storefront.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus comprising:
a clamping mechanism comprising a first surface and a second surface;
a shaft along which the second surface of the clamping mechanism may travel; and
a head associated with a first end of the shaft, the head having a channel and a hook.

2. The apparatus of claim 1, wherein the clamping mechanism further comprises at least one of a coarse adjustment or a fine adjustment.

3. The apparatus of claim 1, wherein the head further comprises an insert associated with the channel.

4. The apparatus of claim 1, wherein the head further comprises a retainer associated with the channel.

5. The apparatus of claim 1, wherein the head further comprises a second channel.

6. The apparatus of claim 5, wherein the head further comprises a first retainer associated with the channel and a second retainer associated with the second channel.

7. The apparatus of claim 1 further comprising:
a stabilizer bar associated with the head and the shaft.

8. An apparatus for securing a banner without tying down the bottom of the banner, the apparatus comprising:
a mounting fixture comprising:
a clamping mechanism comprising a first surface and a second surface;
a shaft along which the second surface of the clamping mechanism may travel; and
a head associated with a first end of the shaft, the head having a channel and a hook; and
a rod extending through the channel and into a pocket of the banner.

9. The apparatus of claim 8, wherein the rod has a desirable flexibility and a desirable strength.

10. The apparatus of claim 8, wherein a length of the rod is greater than a length of the banner.

11. The apparatus of claim 8, wherein the pocket is tapered along a length of the rod.

12. The apparatus of claim 8, wherein the head further comprises a second channel, the apparatus further comprising:
a second rod extending through the second channel and into a second pocket of the banner.

13. The apparatus of claim 12, wherein the second pocket is tapered along a length of the second rod.

14. The apparatus of claim 8 further comprising:
a second mounting fixture comprising:
a second clamping mechanism comprising a third surface and a fourth surface;
a second shaft along which the fourth surface of the second clamping mechanism may travel; and
a second head associated with a first end of the second shaft, the second head having a second channel and a second hook; and
a second rod extending through the second channel and into a second pocket of the banner.

15. A method of securing a banner without tying down the bottom of the banner, the method comprising:
clamping a structure using a clamping mechanism of a mounting fixture;
hanging a grommet of the banner onto a hook of the mounting fixture; and
inserting a rod through a channel of the mounting fixture and into a first pocket of the banner.

16. The method of claim 15, wherein clamping the structure using a clamping mechanism comprises clamping the structure between at least one of a stabilizer bar or a first surface and a second surface of the clamping mechanism using at least one of a coarse adjustment or a fine adjustment.

17. The method of claim 15 further comprising:
activating a retainer to hold the rod in place within the channel.

18. The method of claim 15 further comprising:
clamping the structure using a second clamping mechanism of a second mounting fixture;
hanging a second grommet of the banner onto a hook of the second mounting fixture; and
inserting a second rod through a second channel of the second mounting fixture and into a second pocket of the banner.

19. The method of claim 15 further comprising:
inserting a second rod through a second channel of the mounting fixture and into a second pocket of the banner.

20. The method of claim 15 further comprising:
associating a bottom straightener with a second grommet and a third grommet of the banner.
